(19) United States
(12) Patent Application Publication
(10) Pub. No.: US 2004/0181512 A1
(43) Pub. Date: Sep. 16, 2004

(54) System for dynamically building extended dictionaries for a data cleansing application

(75) Inventors: Douglas R. Burdick, Ithaca, NY (US); Robert J. Szczerba, Endicott, NY (US)

Correspondence Address: TAROLLI, SUNDHEIM, COVELL & TUMMINO LLP, 1111 LEADER BLDG., CLEVELAND, OH, 44114, US

(73) Assignee: Lockheed Martin Corporation

(21) Appl. No.: 10/386,097

(22) Filed: Mar. 11, 2003

(51) Int. Cl. G06F 7/00

(52) U.S. Cl. 707/3

(57) ABSTRACT

A system builds an extended dictionary for a data cleansing application. The system includes a record collection. Each record in the collection includes a list of fields and data contained in each field. The system further includes an input dictionary defining predetermined valid values for variants of values in at least one of the fields and a set of rules derived from patterns of the field values. The system still further includes an extended dictionary including the input dictionary and the rules.

### FIELD OF THE INVENTION

The present invention relates to a system for building a dictionary and, more particularly, to a system for dynamically building an extended dictionary for a data cleansing application.

### BACKGROUND OF THE INVENTION

In today's information age, data is the lifeblood of any company, large or small, federal or commercial. Data is gathered from a variety of different sources in a number of different formats or conventions. Examples of data sources would be: customer mailing lists, call-center records, sales databases, etc. Each record contains different pieces of information (in different formats) about the same entities (customers in this case). Data from these sources is either stored separately or integrated together to form a single repository (i.e., data warehouse or data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this situation. The quality of the analysis performed by these tools suffers dramatically if the data analyzed contains redundant, incorrect, or inconsistent values. This “dirty” data may be the result of a number of different factors including, but certainly not limited to the following: spelling errors (phonetic and typographical), missing data, formatting problems (wrong field), inconsistent field values (both sensible and non-sensible), out of range values, synonyms or abbreviations, etc.

Because of these errors, multiple database records may inadvertently be created in a single data source relating to the same object (i.e., duplicate records) or records may be created which don't seem to relate to any object (i.e., “garbage” records). These problems are aggravated when attempting to merge data from multiple database systems together, as in data warehouse and/or data mart applications. Properly reconciling records with different formats becomes an additional issue here.

To help mitigate these issues, a data dictionary is typically made available to a cleansing application. The data dictionary may contain a listing of correct values, and their commonly used variants (i.e., using St. for Street, Ave. for Avenue, Jim for James, etc.). This dictionary may be viewed as a “lookup” table associating these equivalent values together. A data cleansing application may use this data dictionary for the steps of parsing, correction/validation, and standardization.

Parsing may involve intelligently breaking a text string into a plurality of correct data fields, as illustrated in FIG. 1. Typically, the a text string is not found in an easily readable format and a significant amount of decoding needs to be done to determine which piece of text corresponds to what particular data field. Note that this step does not involve error correction.

Records may be formatted or free form. Formatted records have field values stored in a fixed order, and properly delineated. Free-form records have field values stored in a fixed order, and properly delineated. Free-form records have field values stored in any order, and it might not be clear where one field ends and another begins.

Once a string is parsed into appropriate fields, a validation step may determine whether field values are in a proper range and/or are valid, as illustrated in FIG. 2. This step may only be performed if a “truth” criteria exists for a given field, typically input as a dictionary of correct, known values. A correction step, also illustrated in FIG. 2, may update existing field values to reflect a specific truth value (i.e., correcting the spelling of “Pittsburgh” in FIG. 2, etc.).

A standardization step may arrange data in a consistent manner and/or a preferred format in order to compare the data against data from other sources, as illustrated in FIG. 3. Together, the steps of parsing, correction/validation, and standardization may transform records into a “good form” by removing most sources of mistakes and putting the records into a single, standard, and consistent format.

The steps of parsing, correction/validation, and standardization are particularly intensive if records come from different sources (i.e., multiple databases brought together to create a data warehouse, etc.). Once these steps have been performed, a data cleansing application may apply other steps to identify duplicate records that refer to the same real-world entity (i.e., clustering, matching, merging, etc.).

The accuracy of a data cleansing application in performing the parsing, correction/validation, and standardization steps depends heavily on the completeness of a dictionary (i.e., the dictionary includes most variants of correct values, etc.). The dictionary is the source of “truth” values for use by the data cleansing application. Thus, a greater amount of information encoded in the dictionary may allow a cleansing application to cleanse the record collection with greater accuracy (i.e., to perform the above steps of a data cleansing application correctly for a greater number of values in the record collection, etc.).

Existing dictionaries are usually hand-coded with likely alternative representations determined by a human domain expert. Additionally, for many applications, there may already exist a dictionary of such alternative representations. Conventional methods do not intelligently extend a given dictionary, either by discovering patterns across several fields (i.e., dependence and association rules, etc.) or patterns in the field values and known variants already encoded in the dictionary.

Further, for some data cleansing applications, a complete dictionary may not exist (i.e., a legacy warehouse inventory that has evolved over many years, etc.). Additionally, non-standard “ad-hoc” variants may commonly be used in the data collection.

For example, “Internal Research and Development” may commonly be referred to as “IRAD”, “IR&D”, or “Internal R&D”. These variants may commonly be abbreviations and/or acronyms created for convenience.

Since the variations of this example are syntactically similar (i.e., the abbreviation or acronym variant matches a regular expression relative the valid value, etc.), unseen variants of other values for a record field not encoded in the dictionary may be identified by examining the value in the record field itself. In this example, the variation “looks” similar (e.g., same letters, same ordering, etc.).

To identify variants that are completely different syntactically, more information than simply the field values is needed. For example, in addresses, city names are often replaced by “vanity names” (i.e., Cayuga Heights for Ithaca, Hollywood for Los Angeles, etc.). The relationship of ZIP codes being unique to City and State combinations may be used. Since Cayuga Heights, N.Y. and Ithaca, N.Y. have the same ZIP code, Cayuga Heights may be identified as a variant of Ithaca.

### SUMMARY OF THE INVENTION

A system in accordance with the present invention builds an extended dictionary for a data cleansing application. The system includes a record collection. Each record in the collection includes a list of fields and data contained in each field. The system further includes an input dictionary defining predetermined valid values for variants of values in at least one of the fields and a set of rules derived from patterns of the field values. The system still further includes an extended dictionary including the input dictionary and the rules.

A method in accordance with the present invention builds an extended dictionary for a data cleansing application. The method includes the following steps: providing a record collection, each record in the collection having a list of fields and data contained in each field; providing a dictionary defining predetermined valid values for variants of values in at least one of the fields; deriving a set of rules from patterns of the field values; and extending the dictionary utilizing the rules.

A computer program product in accordance with the present invention builds an extended dictionary for a data cleansing application. The product includes a record collection. Each record in the collection includes a list of fields and data contained in each field. The product further includes an input dictionary defining predetermined valid values for variants of values in at least one of the fields and a set of rules derived from patterns of the field values. The product still further includes an extended dictionary including the input dictionary and the rules.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of a process for use with the present invention;

FIG. 2 is a schematic representation of another process for use with the present invention;

FIG. 3 is a schematic representation of still another process for use with the present invention;

FIG. 4 is a schematic representation of example data for use with the present invention;

FIG. 5 is a schematic representation of an example system in accordance with the present invention;

FIG. 6 is a schematic representation of example data for use with the present invention; and

FIG. 7 is a schematic representation of example output of the present invention.

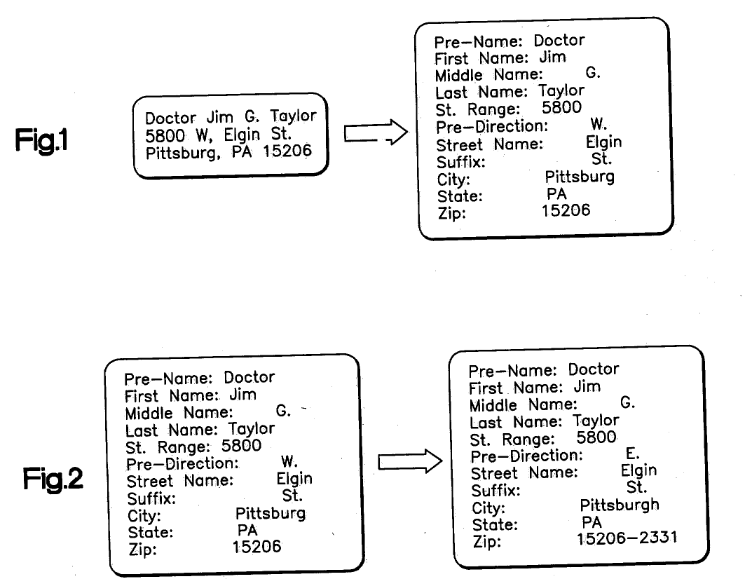

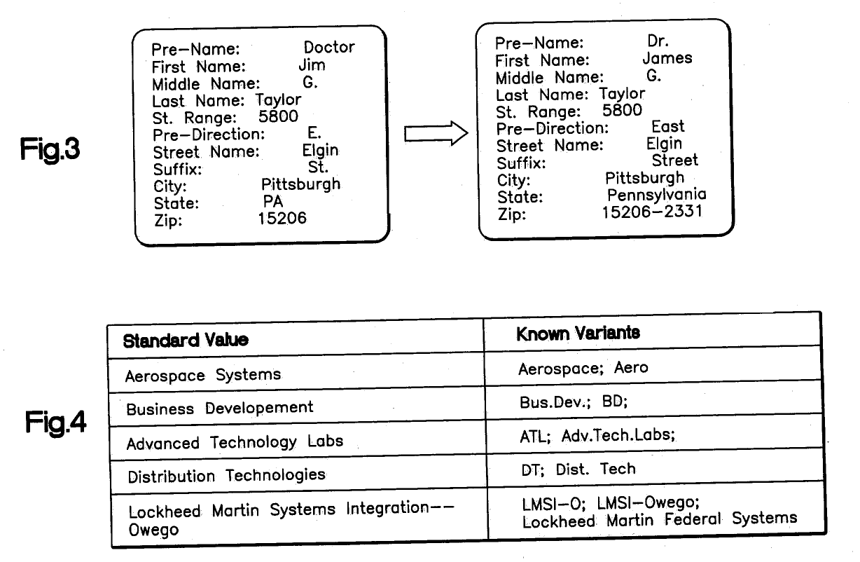

### DETAILED DESCRIPTION OF AN EXAMPLE EMBODIMENT

A system in accordance with the present invention may produce a more robust, extended dictionary for each record field in a record collection. The system may identify field patterns for generating likely and unseen variants of valid field values not originally encoded in the dictionary. These variant generating patterns may be utilized by applying data mining and regular expression mining techniques to the given dictionary.

The system may be given a data dictionary as input. The data dictionary includes, for each record field, a listing of all valid values for each record field, and for each valid value a list of known variants. The dictionary may be in the form of a lookup table associating a valid value with a list of alternative values. An example of a partial dictionary is illustrated in FIG. 4.

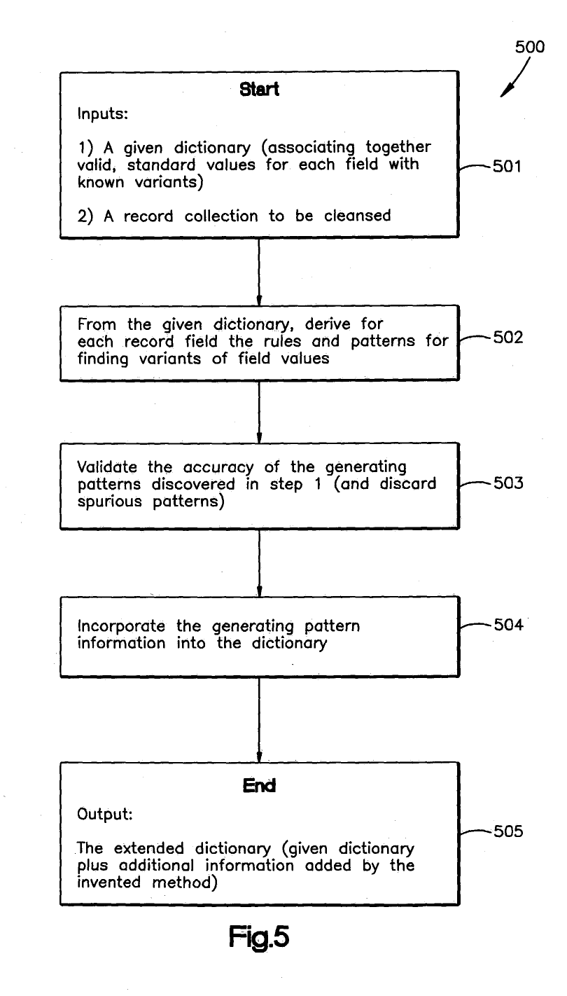

An example system 500 in accordance with the present invention is illustrated in FIG. 5. In step 501, the system 500 inputs a dictionary and a record collection. Following step 501, the system proceeds to step 502. In step 502, from the input dictionary, the system 500 derives rules and patterns for finding variants of field values for each record field.

In step 502, the system 500 may generate patterns for discovering variants based on the field values. Methods for performing step 502 may be based on generating regular expressions describing how a variant value may be derived from a given standard value. Acronyms and abbreviations may be identified. Step 502 may also process basic errors such as common typographical errors. These patterns are based exclusively on regular expressions.

There are numerous methods for determining such regular expressions. For example, the system 500 may consider “Internal Research and Development” and its variants. For determining regular patterns to describe possible acronyms of the term “Internal Research and Development,” the system 500 may use a heuristic rule such as acronyms include the first letter of the main words in the term. Thus, the acronym, at the least, would contain the “I” from “internal,” “R” from “research” and “D” from “development.” The regular expression capturing this pattern would be “IR*D,” where the ‘*’ represents between 0-3 alphanumeric characters. This rule prevents spurious strings from matching (like irritated), while also processing variations such as “IR and D.” Since the system 500 is not applying these regular expressions to free text, the expressions may be evaluated over a limited vocabulary of strings (i.e., only other values in the same record field, etc.).

Step 502 may also generate dependency rules for variants by using multiple record fields. Multiple record fields may be useful for recognizing variants of a field value having no syntactic similarity to the underlying valid value (i.e., the “vanity address” example above, etc.). The record collection may next be examined to determine the existence of dependencies between field values. A dependency may indicate that the values for a field (or combination of fields) may be used to predict the value in another field. For example, in addresses, the combination of (State and ZIP code) values can be used to predict the value for City. Thus, if two records have the same State and ZIP code, then they may be meant to have the same city value. If the 2 records have different city values, then these are variants of each other.

Two records may have the following addresses: “104 Brook Lane, Ithaca, N.Y., 14850” and “104 Brook Lane, Cayuga Heights, N.Y., 14850.” Since the State and ZIP code values are the same, the city value must be the same. Thus, Cayuga Heights and Ithaca must be variants of the same value for city name. Allowing for errors and alternative representations dictates that these dependencies may not be accurate all of the time.

Additionally, any approach to step 502 requires some method to verify that the patterns learned in step 502 make sense, and are not false dependencies based on errant “dirty” values in the record collection. The system 500 may account for this by accepting patterns from statistically significant correlations. For example, a perfect functional dependency may be: for every possible value X that field A has, the following rule holds: IF (field A of Record 1 has value X), THEN (field B of Record 1 has value Y). Conversely, the system 500 may generate rules such as: FOR a d% of the possible values for field A, then either of the following holds −1) IF (field A of Record 1 has value X), THEN (field B of Record 1 has value Y 100% of the time) OR 2) IF (field A of Record 1 has value X) AND (at least s% of all Records have value X for field A), THEN (field B of Record 1 has value Y c% of the time), where d, s, c are numbers less than 100%. These rules may be variants on association rules, and s and c may be referred to as “support” and “confidence” of the rule, respectively.

Step 502 of the system 500 may create a rule only if the association rule holds for a significant portion of the values field A may have. Clause 1 is identical to the perfect dependency. Clause 2 is meant to process possible errors by relaxing the constraint for frequent values of field A. While the rules described above are simple, the same concepts may be extended to allow dependencies in multiple fields and clauses with multiple levels of s and c for different field combinations.

Rules that have a strong statistical significance may be presented to a user for feedback as to whether the system 500 has made valid inferences. Statistical significance may be measured in numerous ways. The level of significance the user is interested in will determine the values assigned to d, s, and c in the rules. If the user is a domain expert, the user may also suggest rules or what rules for which to look. User suggestions may improve efficiency of the system 500, but are not necessary. For example, a user may suggest between which fields to look for dependencies. The system 500 may use conventional methods to efficiently compute these association rules over large data sets.

The above examples illustrate patterns that may be generated from the input dictionary. More sophisticated approaches may include combining regular expressions together with dependency rules (i.e., requiring the matching of the regular expression in the field along with the dependency rule, etc.) and assigning to each regular expression and/or dependency rule a numerical weight. If the sum of the weights of the expressions and/or rules the variant candidate satisfies (relative to the valid value in question) are above a certain threshold, then the system 500 may consider the candidate a variant. Otherwise, the system 500 may consider the two values different.

Following step 502, the system 500 proceeds to step 503. In step 503, the system 500 validates the accuracy of the patterns generated by step 502 and discards spurious patterns. A spurious pattern is one that is correct in the sample data, but does not hold for the larger record collection. Therefore, in this case, a pattern discovered in step 502 may be accurate for the input dictionary, but should not be generalized for additional values.

To prevent spurious patterns from being included in the generated patterns, the system 500 validates the accuracy of the learned patterns. If a learned pattern for a specific field has a high degree of accuracy, then the system uses it to generalize the input dictionary. If not, then the system 500 drops the learned pattern as spurious.

The system 500 may select, from each record, several fields, apply a generating function, and present the results to a user for verification. The user may provide input whether the presented value could be a valid variation on the standardized value. If the rule may be used to accurately generate variants for enough of the standard values, then the system 500 includes the rule as a generated pattern.

Following step 503, the system 500 proceeds to step 504. In step 504, the system 500 incorporates the generated pattern information into the input dictionary. The system 500 thus extends the input dictionary by incorporating the generated pattern information into the input dictionary.

Typically, the association rules (i.e., dependence rules, etc.) may only be checked when a data cleansing application is processing a record collection. Thus, the rules are stored in the dictionary. For each record field, the system 500 may apply the appropriate regular expression patterns to each field value and add the results to the dictionary as variants of the generated value. Following step 504, the system 500 proceeds to step 505. In step 505, the system 500 outputs the extended dictionary to an appropriate data cleansing application.

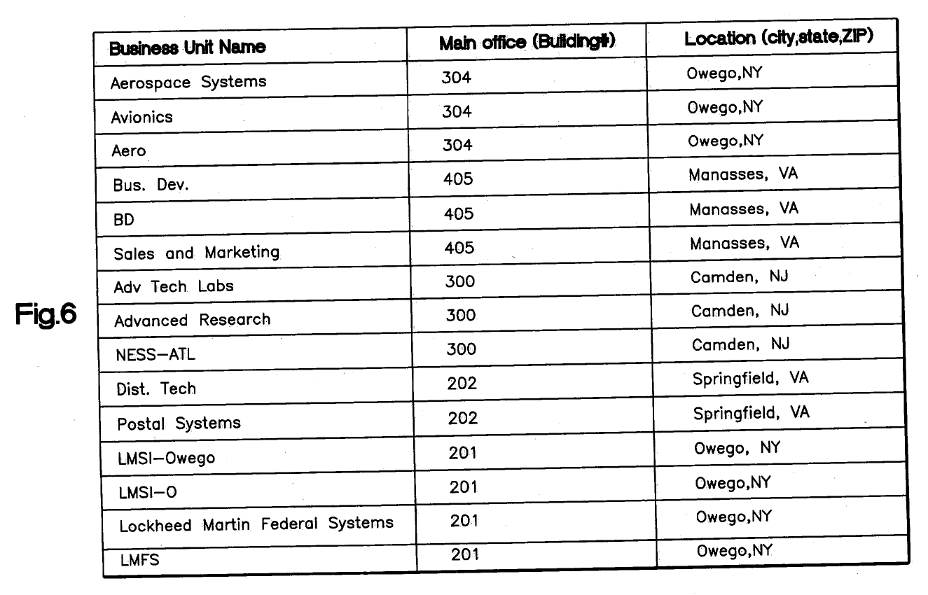

An example of the functioning of the system 500 is illustrated below for the sample database of FIG. 6. The example record collection given in FIG. 6 consists of 15 records, and each record has 3 fields: business unit name, building number, and location. The example dictionary of FIG. 4 and its business unit name variants are assumed to be given as the input dictionary to the system 500.

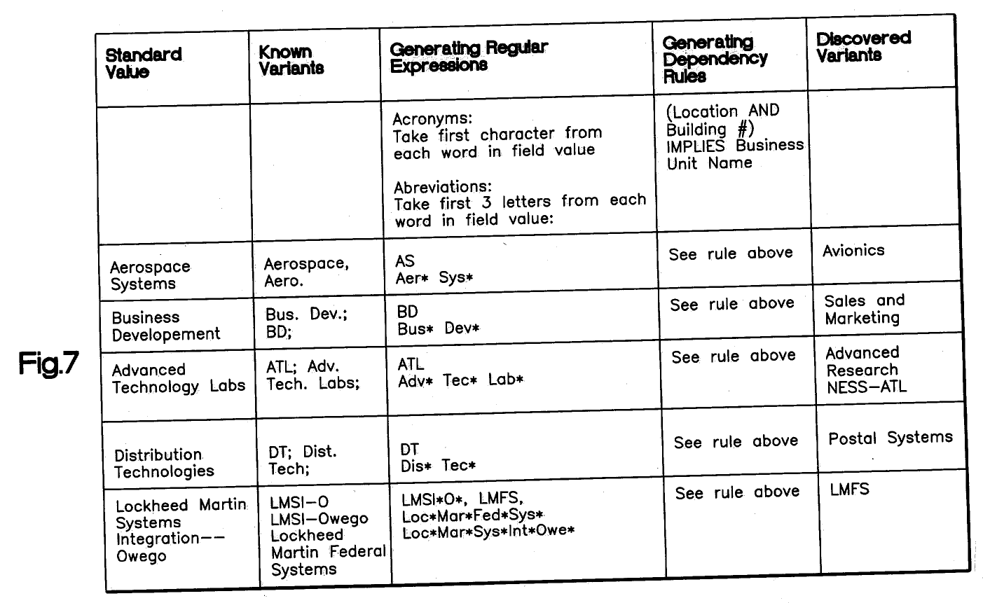

The extended dictionary output by the example system 500 is illustrated in FIG. 7. The example extended dictionary includes: the information from the given dictionary (columns 1 and 2); the generated regular expressions learned from examining the given dictionary in Step 502 (column 3—the first line gives the rules used to generate the regular expressions); the generated dependencies that were learned in step 502 (column 4); and the discovered variants (column 5).

Another example system in accordance with the present invention may extend a given dictionary of known correct values for each record field to include unseen alternative representations of the known correct value. This extended dictionary may allow a data cleansing application to recognize values that have not been explicitly included in a given dictionary, and to associate them with the correct value in the dictionary, despite a lack of explicit encoding in the dictionary. A data cleansing application using a dictionary generated by this system may have greater accuracy and robustness when cleansing a given record collection, since the data application may now process values in the record collection not in the dictionary in a more intelligent manner. The system intelligently derives patterns for predicting likely forms of unseen variants of standard values in the dictionary. The patterns may be derived from an input dictionary and from patterns/correlations in the subject record collection. The patterns may then be used by the system to extend the input dictionary.

The example system may create a generalized dictionary by deriving patterns from similar values that have already been encoded into the dictionary input into the data cleansing application. The accuracy of the data cleansing application using the extended dictionary generated by the system to perform the parsing, correction/validation, and standardization steps may have increased accuracy above the use of the unextended input dictionary.

A computer program product in accordance with the present invention builds an extended dictionary for a data cleansing application. The product may include a record collection. Each record in the collection includes a list of fields and data contained in each field. The product may further include an input dictionary defining predetermined valid values for variants of values in at least one of the fields and a set of rules derived from patterns of the field values. The product may still further include an extended dictionary including the input dictionary and the rules.

From the above description of the invention, those skilled in the art will perceive improvements, changes and modifications. Such improvements, changes and modifications within the skill of the art are intended to be covered by the appended claims.

Having described the invention, the following is claimed:

1. A system for building an extended dictionary for a data cleansing application, said system comprising:
a record collection, each record in said collection includes a list of fields and data contained in each said field;
an input dictionary defining predetermined valid values for variants of values in at least one of said fields;
a set of rules derived from patterns of said field values; and
an extended dictionary including said input dictionary and said rules.

2. The system as set forth in claim 1 wherein the accuracy of said rules is validated by said system.

3. The system as set forth in claim 2 wherein at least one of said rules is discarded.

4. The system as set forth in claim 1 wherein said extended dictionary is utilized as part of a correction step of the data cleansing application.

5. The system as set forth in claim 1 wherein said extended dictionary is utilized as part of a validation step of the data cleansing application.

6. The system as set forth in claim 1 wherein said extended dictionary is utilized as part of a standardization step of the data cleansing application.

7. A method for building an extended dictionary for a data cleansing application, said method comprising the steps of:
providing a record collection, each record in the collection having a list of fields and data contained in each field;
providing a dictionary defining predetermined valid values for variants of values in at least one of the fields;
deriving a set of rules from patterns of the field values; and
extending the dictionary utilizing the rules.

8. The method as set forth in claim 7 further including the step of validating the rules.

9. The method as set forth in claim 8 further including the step of discarding at least one of the rules that is deemed inaccurate.

10. The method as set forth in claim 7 further including the step of utilizing the extended dictionary as part of a correction step of the data cleansing application.

11. The method as set forth in claim 7 further including the step of utilizing the extended dictionary as part of a validation step of the data cleansing application.

12. The method as set forth in claim 7 wherein the extended dictionary is utilized as part of a standardization step of the data cleansing application.

13. A computer program product for building an extended dictionary for a data cleansing application, said product comprising:
a record collection, each record in said collection includes a list of fields and data contained in each said field;
an input dictionary defining predetermined valid values for variants of values in at least one of said fields;
a set of rules derived from patterns of said field values; and
an extended dictionary including said input dictionary and said rules.

14. The product as set forth in claim 13 wherein the accuracy of said rules is validated by said product.

15. The product as set forth in claim 14 wherein at least one of said rules is discarded.

16. The product as set forth in claim 13 wherein said extended dictionary is utilized as part of a correction step of the data cleansing application.

17. The product as set forth in claim 13 wherein said extended dictionary is utilized as part of a validation step of the data cleansing application.

18. The product as set forth in claim 13 wherein said extended dictionary is utilized as part of a standardization step of the data cleansing application.
